(19) United States
(12) Patent Application Publication
(10) Pub. No.: US 2022/0206321 A1
(43) Pub. Date: Jun. 30, 2022

(54) EYEGLASS LENS REPLACEMENT ASSEMBLY

(71) Applicant: YI-PING TUNG, TAINAN CITY (TW)

(72) Inventor: YI-PING TUNG, TAINAN CITY (TW)

(21) Appl. No.: 17/137,866

(22) Filed: Dec. 30, 2020

(51) Int. Cl. G02C 13/00; G02C 7/16; G02C 9/04

(52) U.S. Cl. CPC G02C 13/001; G02C 9/04; G02C 7/16

(57) ABSTRACT

An eyeglass lens replacement assembly is revealed. A limiting slot is formed on each side of a frame and a limiting stopper is arranged in the limiting slot. A temple pivot member is mounted in the limiting slot. A lens is mounted to a lens connection portion of the frame and two sides of the lens are inserted into insertion slots of the temple pivot members. Each side of the lens is provided with a positioning dent which is locked with a positioning bulge of the insertion slot. A limiting bulge of a positioning portion pivoted on the temple pivot member is limited in a limiting notch of the lens while a locking recess of the positioning portion is locked and positioned by an inner wall surface of the insertion slot. Thereby the frame, the temple pivot members and the lens are combined with and connected to one another firmly.

### BACKGROUND OF THE INVENTION

### Field of the Invention

The present invention relates to an eyeglass lens replacement assembly, especially to an eyeglass lens replacement assembly which makes assembly and replacement of eyeglass lens more easily and conveniently, without using any tools. The design also provides quick assembly of the lens.

### Description of Related Art

There are various types of eyeglasses such as optical glasses, sunglasses, sports glasses, night vision glasses, etc. Users can select glasses according to their personal needs at different time so that most of people have several pairs of glasses. For example, the sport glasses used in the daytime protects users from ultraviolet radiation while the sport glasses should allow more light to pass through due to insufficient light at night. However, to buy more eyeglasses costs a lot more money and more space is needed for eyeglasses storage.

The basic structure of the eyeglasses includes a frame which holds at least one lens. After the lens being mounted into a lens assembly hole of the frame, threaded fasteners are inserted into threaded holes of the frame beside the lens assembly hole and threaded into the frame for clamping and fixing the lens inside the lens assembly hole of the frame. Then temples are pivotally connected to two sides of the frame. The assembly of the eyeglasses is completed.

Although the lens can be clamped and fixed inside the lens assembly hole by the threaded fasteners, threaded fastener driving tools are required to tighten or release the threaded fasteners while mounting or removing the lens relative to the lens assembly hole. Thus the assembly or disassembly of the lens is inconvenient once users don't have the right tool on hand.

Thus there is room for improvement and there is a need to provide a novel eyeglass lens replacement assembly which is more convenient to use.

### SUMMARY OF THE INVENTION

Therefore it is a primary object of the present invention to provide an eyeglass lens replacement assembly in which a frame, temple pivot members and a lens are connected firmly with and positioned properly by one another, without falling off easily. During assembly or replacement of the lens, not only no tools are required, related components are also assembled more quickly and conveniently.

In order to achieve the above object, an eyeglass lens replacement assembly according to the present invention mainly includes a frame, two temple pivot members and a lens.

The frame is provided with a lens connection portion, a plurality of mounting protrusions formed on the frame and located around the lens connection portion, a limiting slot formed on each of two sides of the frame, and a limiting stopper arranged in the limiting slot.

The temple pivot member is inserted and mounted in the limiting slot of the frame. An insertion slot is located concavely on a front end of the temple pivot member and provided with a positioning bulge therein. A through slot is formed on an inner side of the temple pivot member and communicating with the insertion slot while a positioning portion is pivotally connected to the through slot and provided with a limiting bulge and a locking recess which is formed on the front end of the positioning portion and locked with an inner wall surface of the insertion slot. A temple is pivotally connected to a distal end of the temple pivot member.

The lens is mounted to the lens connection portion of the frame and two sides of the lens are inserted into the insertion slots of the temple pivot members correspondingly. The lens is composed of a plurality of mounting slots, two positioning dents and two limiting notches. The mounting slots are formed on the periphery of the lens for mounting and positioning the mounting protrusions correspondingly. The two positioning dents are mounted on two sides of the lens and locked and positioned by the positioning bulges of the insertion slots while the two limiting notches are formed on two sides of the lens for locking and limiting the limiting bulges of the positioning portions.

The positioning portion of the temple pivot member is provided with a slip resistant part to which users can easily apply a force for pulling the positioning portion outward.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a side view of an embodiment according to the present invention;

FIG. 3 is a top view of an embodiment according to the present invention;

FIG. 4 is a perspective view of an embodiment according to the present invention;

FIG. 5 is another perspective view of an embodiment according to the present invention;

FIG. 6 is a side view of a section of an embodiment according to the present invention;

FIG. 7 is a top view of a section of an embodiment according to the present invention;

FIG. 8 is a partial enlarged top view of a section of an embodiment according to the present invention.

### DETAILED DESCRIPTION OF THE PREFERRED EMBODIMENT

In order to learn technical content and functions of the present invention more completely and clearly, please refer to the following embodiments with detailed descriptions and with reference to the related figures and numbers therein.

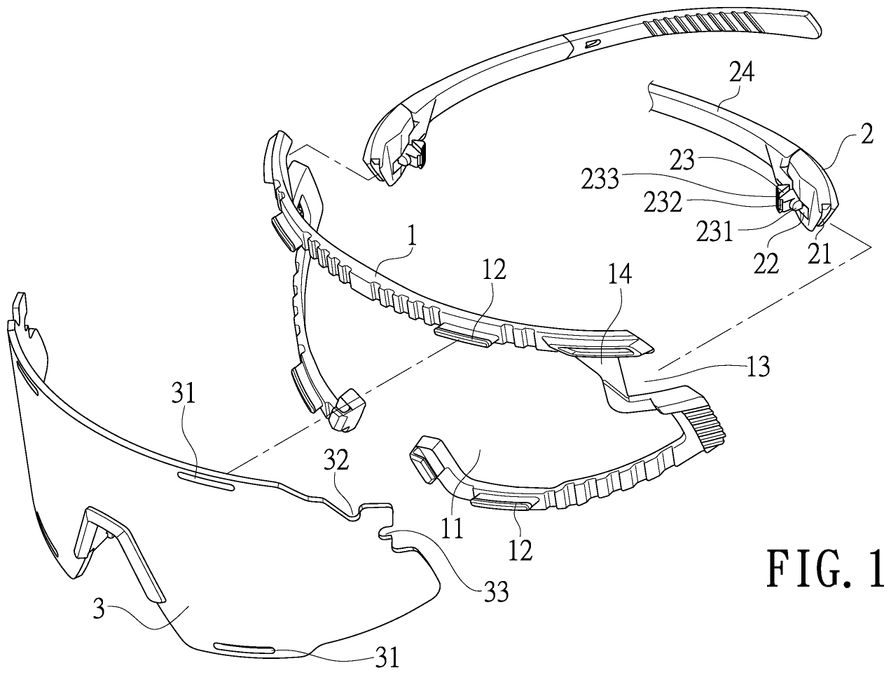

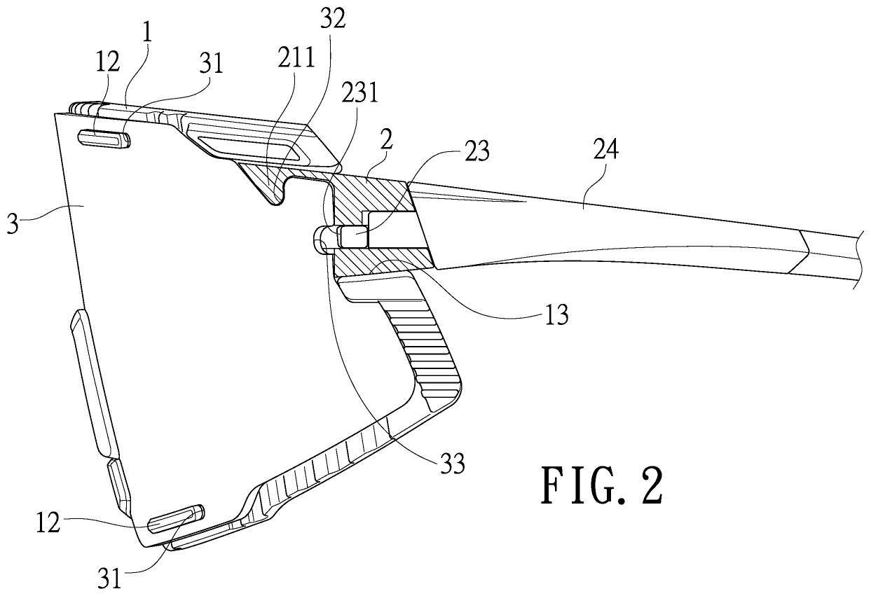

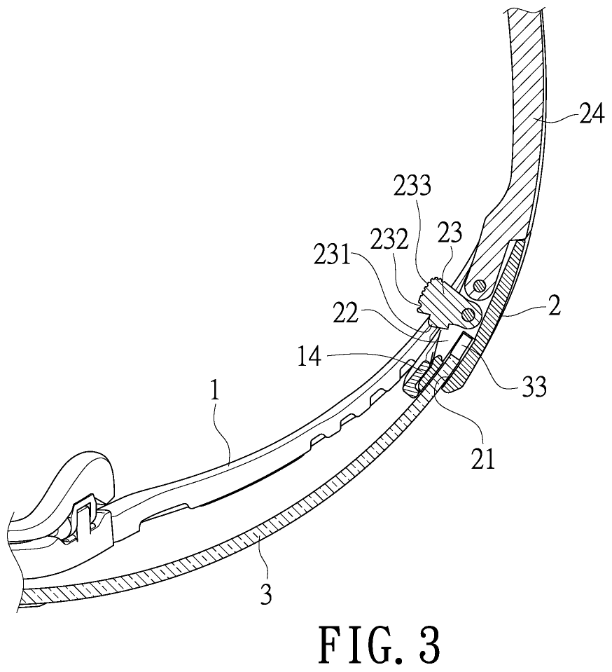

Refer to FIG. 1, FIG. 2 and FIG. 3, an eyeglass lens replacement assembly according to the present invention includes a frame 1, two temple pivot members 2 and a lens 3.

The frame 1 consists of a lens connection portion 11, a plurality of mounting protrusions 12 formed on the frame 1 and located around the lens connection portion 11, a limiting slot 13 mounted on each of two sides of the frame 1, and a limiting stopper 14 disposed in the limiting slot 13.

The temple pivot member 2 which is inserted and mounted in the limiting slot 13 of the frame 1 includes an insertion slot 21 located concavely on a front end of the temple pivot member 2, a through slot 22 formed on an inner side of the temple pivot member 2 and communicating with the insertion slot 21, a positioning portion 23 pivoted on the through slot 22, and a temple 24 pivotally connected to a distal end of the temple pivot member 2. A positioning bulge 211 is formed in the insertion slot 21 while the positioning portion 23 is provided with a limiting bulge 231, a locking recess 232 formed on the front end of the positioning portion 23 and locked and positioned by an inner wall surface of the insertion slot 21 for positioning, and a slip resistant part 233 to which users can easily apply a force for pulling the positioning portion 23 outward.

The lens 3 is mounted to the lens connection portion 11 of the frame 1 and two sides of the lens 3 are inserted into the insertion slots 21 of the temple pivot members 2 correspondingly. The lens 3 is composed of a plurality of mounting slots 31 formed on the periphery of the lens 3 and corresponding to the mounting protrusions 12, two positioning dents 32 mounted on two sides of the lens 3 and corresponding to the positioning bulges 211 of the insertion slots 21, and two limiting notches 33 formed on two sides of the lens 3 and corresponding to the limiting bulges 231 of the positioning portions 23.

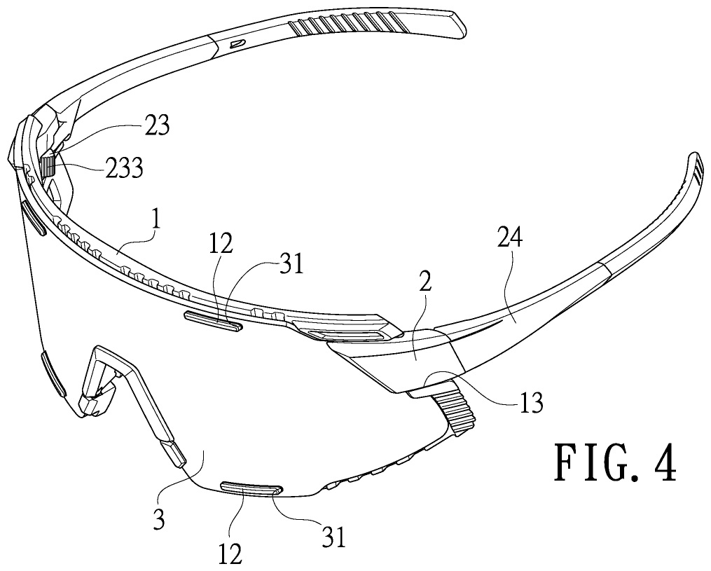

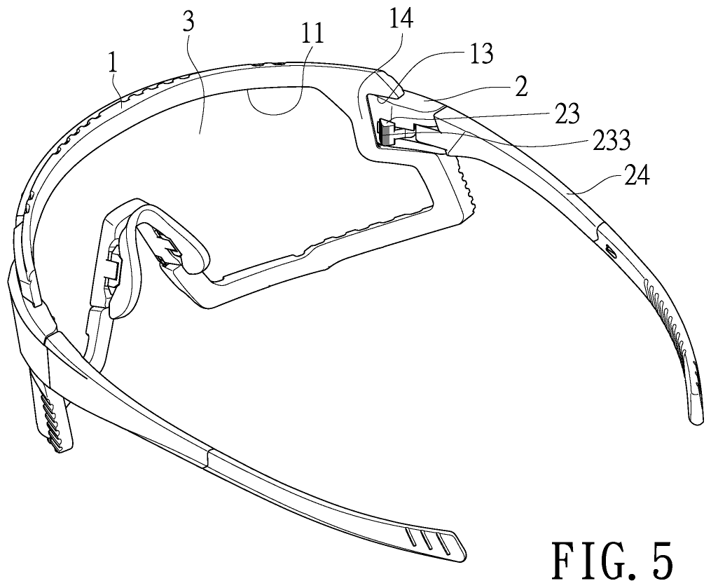

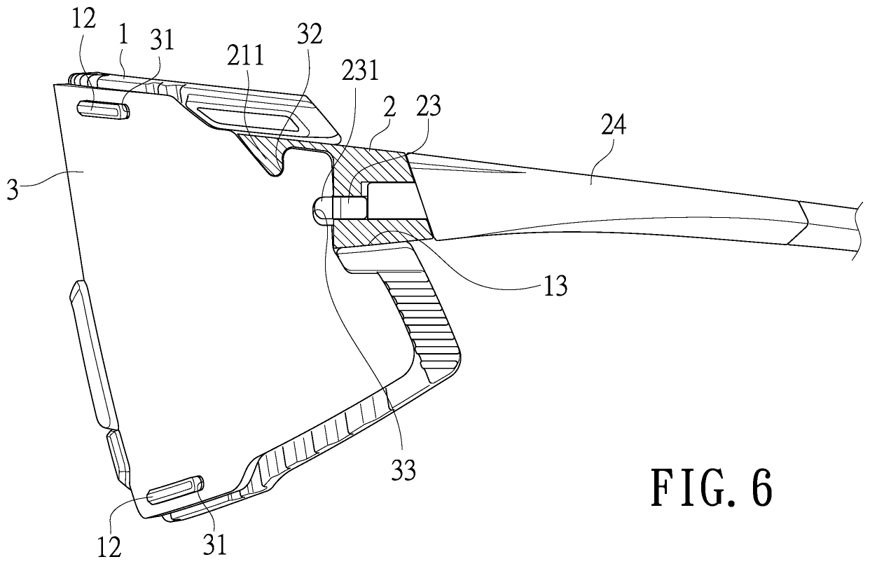

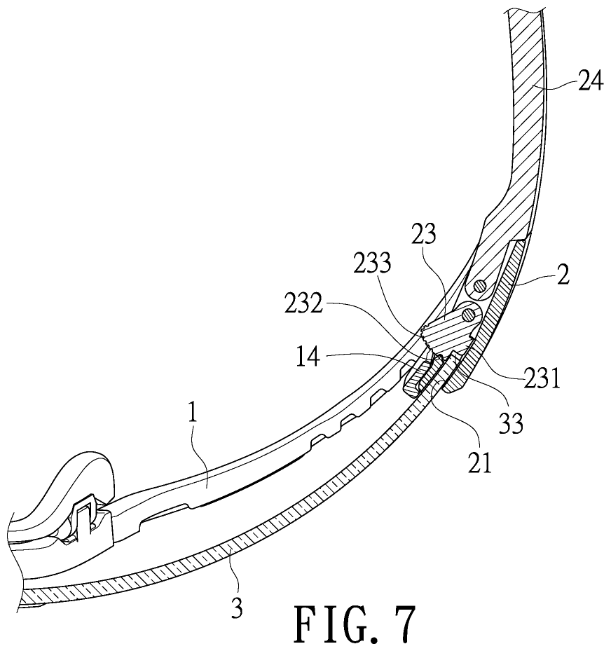

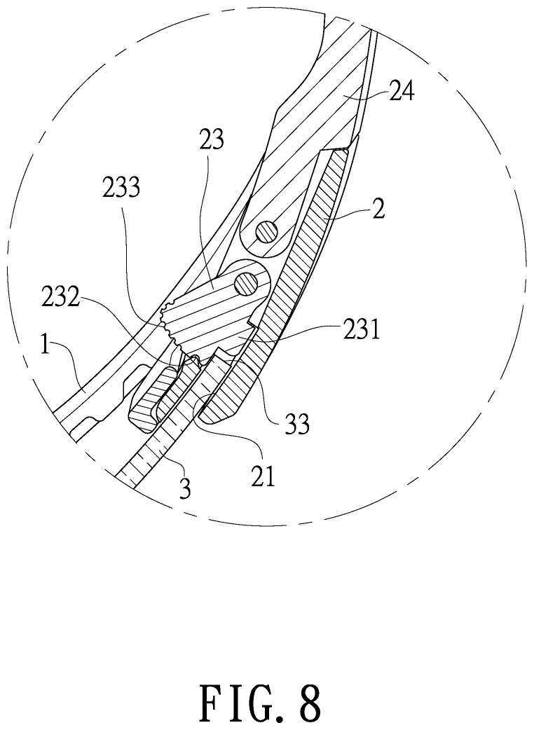

With reference to FIG. 4, FIG. 5, FIG. 6 and FIG. 7, while being assembled, the temple pivot member 2 is inserted and mounted in the limiting slot 13 of the frame 1 so that the upper and lower ends of the temple pivot member 2 are limited and stopped by the limiting slot 13 while a surface of a proximal end of the temple pivot member 2 is also limited and stopped by the limiting stopper 14. Then the lens 3 is aligned with and mounted to the lens connection portion 11 of the frame 1 by two sides of the lens 3 being inserted into the insertion slots 21 of the temple pivot member 2 correspondingly. At the moment, the positioning dents 32 on two sides of the lens 3 are engaged with and positioned by the positioning bulges 211 of the insertion slots 21 while the respective mounting slots 31 on the periphery of the lens 3 and the mounting protrusions 12 around the lens connection portion 11 are mounted and positioned by each other. Next the positioning portion 23 is applied with a force and pressed into the through slot 22 so that the limiting bulge 231 of the positioning portion 23 is locked and limited in the limiting notch 33 of the lens 3. The locking recess 232 on the front end of the positioning portion 23 is locked and positioned by the inner wall surface of the insertion slot 21, as show in FIG. 8. Thereby the temple pivot member 2 is stopped and limited by the limiting slot 13, the limiting stopper 14, and the lens 3 simultaneously so that the frame 1, the temple pivot member 2 and the lens 3 are connected firmly, without falling off easily.

When users want to disassemble or replace the lens 3, a force is applied to the slip resistant part 233 of the positioning portion 23 to pull the positioning portion 23 outward. Thus the limiting bulge 231 of the positioning portion 23 is r the limiting notch 33 of the lens 3. The respective mounting protrusions 12 are also separated from the corresponding mounting slots 31 around the lens 3. Thereby the lens 3 can be removed and replaced.

In summary, compared with the technique available now, the frame, the temple pivot member, and the lens of the present invention are connected and positioned firmly by the frame, the temple pivot member, and the lens in combination with one another, without falling off easily. Not only no tools are required for assembly or replacement of the lens, related components are also assembled more quickly and conveniently.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An eyeglass lens replacement assembly comprising a frame, two temple pivot members and a lens;
wherein the frame includes a lens connection portion, a plurality of mounting protrusions formed on the frame and located around the lens connection portion, a limiting slot mounted on each of two sides of the frame, and a limiting stopper disposed in the limiting slot;
wherein the temple pivot member which is inserted and mounted in the limiting slot of the frame is composed of an insertion slot located concavely on a front end of the temple pivot member and provided with a positioning bulge, a through slot formed on an inner side of the temple pivot member and communicating with the insertion slot, a positioning portion pivoted on the through slot, and a temple pivotally connected to a distal end of the temple pivot member; wherein the positioning portion is provided with a limiting bulge, and a locking recess which is formed on the front end of the positioning portion and locked and positioned by an inner wall surface of the insertion slot for positioning;
wherein the lens is mounted to the lens connection portion of the frame and two sides of the lens are inserted into the insertion slots of the temple pivot members correspondingly; the lens includes a plurality of mounting slots formed on the periphery of the lens and corresponding to the mounting protrusions for being mounted and positioned by each other, two positioning dents mounted on two sides of the lens and corresponding to the positioning bulges of the insertion slots for being locked and positioned by each other, and two limiting notches formed on two sides of the lens for locking and limiting the limiting bulges of the positioning portions.

2. The eyeglass lens replacement assembly as claimed in claim 1, wherein the positioning portion of the temple pivot member is provided with a slip resistant part to which a force is applied for pulling the positioning portion outward.
